(19) United States
(12) Patent Application Publication
(10) Pub. No.: US 2012/0185416 A1
(43) Pub. Date: Jul. 19, 2012

(54) LOAD ESTIMATION IN USER-BASED ENVIRONMENTS

(75) Inventors: Dorit Baras, Haifa (IL); Boaz Carmeli, Koranit (IL); Ohad Greenshpan, Raanana (IL); Edward Vitkin, (US)

(73) Assignee: International Business Machines Corporation, Armonk, NY (US)

(21) Appl. No.: 13/007,684

(22) Filed: Jan. 17, 2011

(51) Int. Cl. G06F 15/18

(52) U.S. Cl. 706/12

(57) ABSTRACT

Method, system, and computer program product for load estimation in a user-based environment. The method includes: inputting a set of time-dependent, raw operational indicators of the environment; creating a load function according to the specific needs of the environment; displaying an estimated load; receiving user feedback on the estimated load; and applying a dynamic learning mechanism to generated a user-tuned load function for estimating load on the environment. The dynamic learning mechanism may be an informative mechanism that supports backtracking to solve user-adaptability problems.

### BACKGROUND

This invention relates to the field of load estimation in user-based environments. In particular, the invention relates to role-tuned, flexible and adaptive estimation of load in multifaceted user-based environments such as hospital emergency departments.

The background and description are explained in the context of hospital emergency departments. However, the described method and system may be applied to other user-based environments such as risk management in security systems. User-based environments are defined as environments in which an end user experiences the operational load of the environment.

Medical informatics, operations researchers, and other decision makers in the healthcare field have yet to come to an agreement regarding standardized metrics for measuring operational load within emergency departments. As a result, it is difficult to develop methods and approaches for reducing operational load.

The rising cost of healthcare services has been a subject of mounting importance and much discussion worldwide. Ample explanations have been proposed, yet regardless of their cause, rising costs impose pressures on healthcare providers to improve the management of quality, efficiency, and economics for their organizations. Significant attention has been given to the question of how to reduce this cost in the healthcare domain.

Hospitals are one of the major players in the provisioning of health services and within hospitals, emergency department (ED) overcrowding has been perhaps the most urgent operational problem. Overcrowding in hospital EDs leads to excessive waiting times and repellent environments, which in turn cause: (1) poor service quality (clinical, operational); (2) unnecessary pain and anxiety for patients; (3) negative emotions (in patients and escorts) that sometimes lead to violence against staff; (4) increased risk of clinical deterioration; (5) ambulance diversion; (6) patients leaving without being seen (LWBS); (7) inflated staff workload; and more.

In order to reduce the occurrence of overcrowding in hospital EDs and optimize ED operations, it is necessary to understand what the current crowding load level is. This means that it is necessary to decide how load on various resources should be defined, to whom it should be presented, and how it should be demonstrated. This task is difficult for several reasons. First, establishing which parameters contribute to the load is complex and subjective. Second, even once the parameters are established, assigning a level of contribution to each one is difficult, due to the varying conditions in each hospital, and to the perceptions of different management teams. Third, the ED is a complex environment that involves various types of entities (e.g., physicians, nurses, patients, executives); each of whom may define the load function differently. Fourth, the definition of load changes from time to time and needs to be updated periodically. Fifth, load may be subjective and difficult to measure objectively. For example, a patient that loudly complains about his pain may significantly add to the subjective load experienced by nurses, doctors or even other patients.

Current load definitions are static formulas created as a result of comprehensive observations and with help of a lot of doctors. The gathered data is averaged to a resulting formula. As a result, these solutions explain “average” ED load behavior for the “average” doctor instead of describing specific ED load for the specific user or role.

### BRIEF SUMMARY

According to a first aspect of the present invention there is provided a method for load estimation in a user-based environment, comprising: inputting a set of time-dependent, raw operational indicators of the environment; creating a load function according to the specific needs of the environment; displaying an estimated load; receiving user feedback on the estimated load; applying a dynamic learning mechanism to generate a user-tuned load function for estimating load on the environment;

According to a second aspect of the present invention there is provided a computer program product for load estimation in a user-based environment, the computer program product comprising: a computer readable storage medium having computer readable program code embodied therewith, the computer readable program code comprising: computer readable program code configured to: inputting a set of time-dependent, raw operational indicators of the environment; creating a load function according to the specific needs of the environment; displaying an estimated load; receiving user feedback on the estimated load; applying a dynamic learning mechanism to generate a user-tuned load function for estimating load on the environment.

According to a third aspect of the present invention there is provided a system for load estimation in a user-based environment, comprising: a processor; an inputs component for inputting a set of time-specific, raw operational indicators of the environment; a load function component for providing a load function according to the specific needs of the environment; a display component for displaying an estimated load on the environment; a user input component for inputting user feedback on the estimated load; a dynamic learning mechanism for applying dynamic learning to generate a user-tuned load function for estimating load on the environment.

### BRIEF DESCRIPTION OF THE SEVERAL VIEWS OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a flow diagram of a method in accordance with the present invention;

FIGS. 2A and 2B are schematic diagrams illustrating the operation of artificial neural networks as used in accordance with the present invention;

FIG. 3 is a block diagram of an embodiment of a system in accordance with the present invention;

FIG. 4 is a block diagram of a computer system in which the present invention may be implemented;

FIG. 5 is a schematic diagram of a tree hierarchy of nodes in accordance with an aspect of the present invention;

FIG. 6 is an example of a user feedback interface in accordance with an aspect of the present invention; and

FIG. 7 is an example of a load tracing display in accordance with an aspect of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Method, system, and computer program product are described in which a flexible and adaptive approach is used that enables the estimation of load in multifaceted user-based environments, using various types of low-level load indicators and defined load functions. A user-based environment is defined as an environment in which an end user experiences the operational load of the environment. The load may have different facets what can be calculated for different roles of the end users. Groups of users that carry out similar tasks are referred to as having the same role.

The estimation of load in user-based environments uses iterative user feedback. Throughout this document the term “user” is used. A user may represent a group of users who carry out the same role. For example, in the medical environment, users may represent the roles of doctors, nurses, managers, etc.

The user feedback is important to correctly reflect the load situation in the environment and the system's calculated load. The user feedback is obtained by using a load presentation mechanism for displaying the estimated load and enabling user feedback on the estimated load. The user feedback may indicate that the load estimate is too high or too low, with incremental indications.

The described solution uses an adaptive function, which learns the setup of a specific environment. Specifically to solve user-adaptability problems, it is proposed to apply a machine learning mechanism that supports backtracking to easily obtain additional useful information. Tuning for the needs of the user makes the system user-specific, resulting in a load score that directly reflects a user's specific perception of the situation. This in turn may be used to represent the perception of the user's role. Multiple users having the same role can be used to average the load estimation across a role. Moreover, the internal structure of such an informative learning mechanism may be used further to trace the load origins, understand its behaviour and provide clues about how to control it.

The solution is based on a machine learning mechanism. An initial explicit definition of load function is defined or estimated (static mechanism) and the load function is tuned (dynamic mechanism) to a user according to received feedback. The dynamic machine learning mechanism enables the system to adapt to the perceptions of users.

The dynamic learning mechanism allows the system to calculate and present different load values for the same objective situation. This is particularly useful for understanding the difference in operational load perception by users in a given role, for example, in an emergency department, physicians, nurses, patients, and the ED management.

The solution provides a highly adaptable load measurement tool that, by scarifying rigid definition for high flexibility, allows users to analytically compare various situations, and to reach informed decisions regarding the appropriate steps to take in order to reduce the environment load.

The solution may be adopted in environments in which the following apply:
Existence of hard or impossible to calculate or define functions, and in which the function value is monitored by a human operator.
Human (implicit) function knowledge.
Diverse set of simple indicators describing the desired function from various angles.
Capturing implicit load parameters such as cognitive load

For example, the following environments are considered:
Load measurement in emergency departments and similar facilities. An ED manager may monitor the load indicators of the system.
Risk measurement in security systems. A system administrator may monitor security alerts.
Operational load measurement in large client service centres.
Operational load in command and control centres, e.g., in army settings.

The estimation of operational load in user-based environments and its presentation are important for improving efficiency. A flexible framework is described for measuring subjective and cognitive load, using iterative user feedback. The framework can be adapted for any user preference and view of the load in specific environments.

The framework receives an extensive set of raw indicators as input. These indicators are a set of measures that are important for the calculation of the environment load. Moreover, this set of indicators can easily be modified according to user needs. The framework receives operational events from the existing environment infrastructure, processes them, and calculates the time-dependent input indicator values.

The framework includes a machine learning mechanism having an initially defined or estimated load function which is tuned according to user feedback. The framework incorporates iterative learning from user feedback on the load estimation generated by the machine learning mechanism.

A user may also provide input in the form of the features used for inputs. For example, a user may decide that a certain input should not be considered if he feels that the feature is not relevant or misleading. A user may also provide input in the choice of parametric family. For example, the choice of artificial neural network together with choice of activation function, or another parametric family.

The system is able to trace the user that provides the feedback and also the role of the user, in order to calculate the load adjusted for that role.

At the outset of the operation of the framework, a load function definition is used. The framework provides a way of defining the explicit load function, based on canonical indicators and the display of that function's behavior during different time frames.

Due to the complexity of an environment such as an emergency department, explicitly defining the load function is often not useful. Therefore, machine learning techniques may be harnessed to solve these issues in a dynamic mechanism. Machine learning mechanism (such as artificial neural networks, or linear regression mechanism) are used as the basic mechanism. These systems are flexible for composition, adaptive over time, meaningful for the user, and enable the definition of complex relationships (e.g., nonlinear) between inputs and outputs.

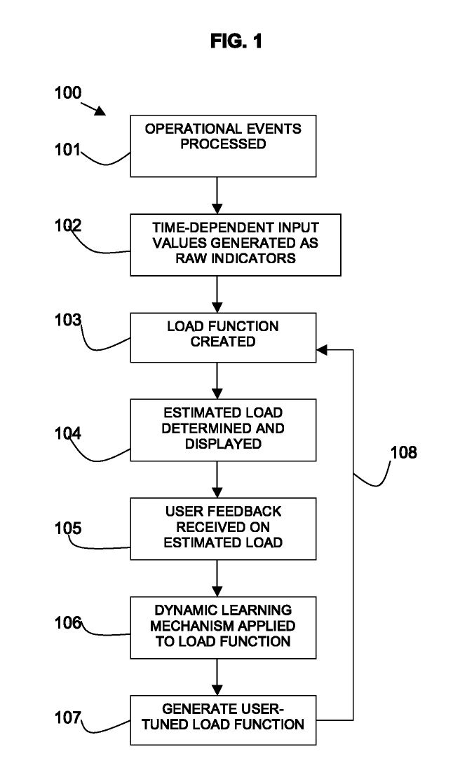

Referring to FIG. 1, a flow diagram 100 shows an embodiment of the described method for estimating load in a user-based environment.

Operational events in an environment are processed 101 to generate 102 time-dependent input values as raw indicators. A load function is created 103 according to the specific needs of the environment. An estimated load is determined and displayed 104 to a user. User feedback on the estimated load is received 105. An informative dynamic learning mechanism is applied 106 to the load function to generate 107 a user-tuned load function. The load function is tuned iteratively by a user feedback loop 108.

A first example embodiment of an informative dynamic learning mechanism is an artificial neural network. Other forms of dynamic learning mechanism may be used, such as linear regression mechanisms which are described later.

### First Embodiment

### Artificial Neural Networks—Theoretical Background

Artificial neural networks are mathematical representations of complex mathematical functions. They are composed of units named perceptrons, and arranged as a multilayered feed-forward network, in which the outputs of one layer are the inputs of the next layer. This type of learning machine was inspired by the brain structure. These machines are successfully used in many applications, such as pattern classification, dimensionality reduction, and function approximation. Because of the origins of the machines' design, the nodes in such networks are often called neurons. The machines' greatest advantage is their simplicity in both representation and learning. In addition, the number of required training examples (that is relative to the network structure) is not high compared to other machine learning solutions.

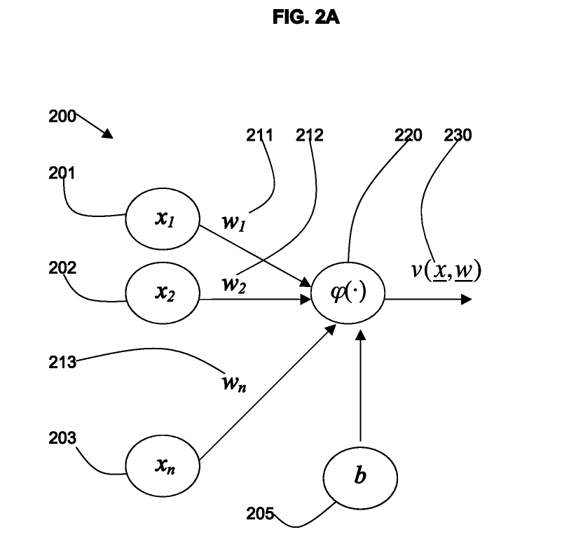

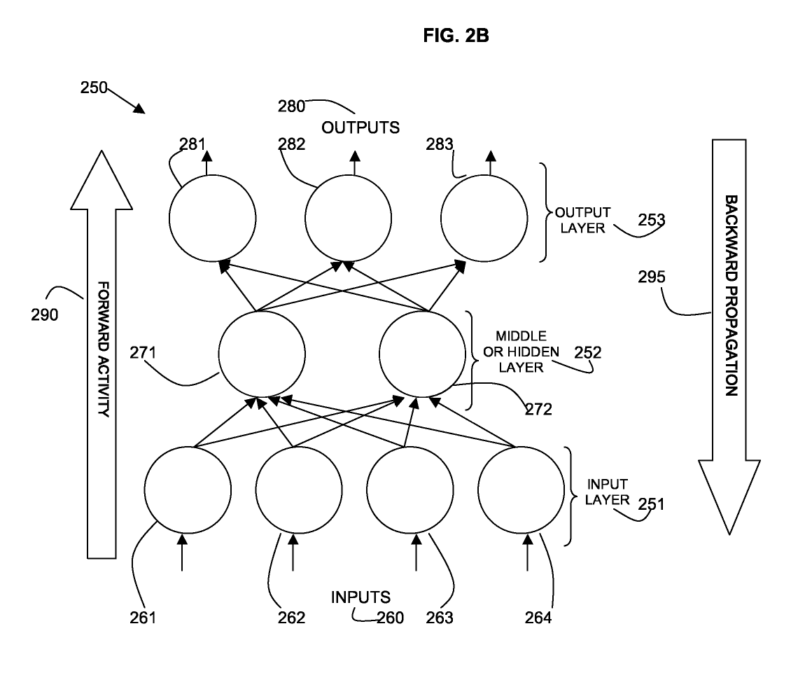

Referring to FIG. 2A, a diagram of a perceptron 200 is provided. Each perceptron 200 is composed of n inputs, x₁, x₂, . . . , xₙ, 201-203, n weights w₁, w₂, . . . , wₙ 211-213, and an activation function φ (•) 220. A bias b 205 is provided as the scalar that multiples the 1 in each sample x. The output 230 of the unit is v(x, w)=φ(x^{t}w), where x=(1, x₁, . . . xₙ), w=(b, w₁ . . . wₙ). Examples of activation functions are sign (φ(u))=sign(u)), linear function (φ(u)=u), and logistic function (φ(u)=1/(1+e^{-u})). The type of activation function affects the ability of the network to learn and is application-dependent.

Referring to FIG. 2B, an example multi-layer network 250 is shown. In the example shown an input layer 251 has input units 261-264 for receiving inputs 260. A middle or hidden layer 252 has units 271-272. An outer layer 253 has units 281-283 with outputs 280. The units in different layers are connected in a feed-forward style or forward activity 290 to determine the network structure. The exact structure is also application-dependent, and in many cases, domain knowledge can help to determine this structure.

Given a training set of the form (xᵢ, yᵢ)ᵢ₋₁^{M}, in which xᵢ ε [symbol] ⁿ is the input to the network and yᵢε [symbol] is the expected output or target function of the network, a back propagation algorithm 295 can be used to find a set of weights that minimizes the mean square error (MSE) between the expected output and the current calculated output. There are two types of learning—offline (or batch) learning, and online learning. In offline learning, the entire training set is given in advance. In each iteration of the back propagation algorithm, all of the examples are taken into account when updating the weights. In online learning, the examples are given one after the other, and each learning iteration depends on the current example only. Online learning is typically used when the environment changes over time, and when the network is trained to fit those changes.

### Input Layer—Raw Indicators

Over the course of healthcare research history, several tens and even hundreds of different load indicators have been defined, such as the number of people in the ED or the percentage of patients arriving in ambulances. Users may choose a subset of such indicators relevant to their specific ED setting. Another option is to take all the available indicators and allow the system to learn the relevant ones dynamically by updating the appropriate weights on the edges. The indicators may all be applied at the same time slot (last hour, last 30 minutes, etc.) to avoid inconsistencies. Each chosen indicator serves as a single input to a neuron node that is created in the input layer. For example, “average doctor's occupancy” indicator is highly relevant while calculating physicians' load at the ED. This indicator is less significant while measuring load on nurses.

### Middle Layer—Network Structure

Two alternative embodiments are described for creating the middle layer:

a) a standard hidden layer, where each neuron of the previous layer feeds all the neurons in the following layer, and

b) a manually created clustering structure based on an understanding of the problem.

A manually created tree-like hierarchy of clusters of indicators may make the system more meaningful and usable since each internal neuron preserves its operational meaning. Moreover, the network has a tree-like connectivity neuron operation, meaning that it remains independent from the adjusted nodes' weight. This allows the user to back-trace the system load bottle-necks and get meaningful alerts on local problems even before they start to affect the entire system. For example, an ED manager can get an alert from the internal neuron when particular stations start to be overloaded, for example, medical imaging stations. This indicator which combines all the inputs from medical imaging services may point to a bottleneck at that section of the ED. The alert may urge the ED manager to solve the problem before it grows and affects other facilities and the overall load situation.

### Output Layer—Load Score

The network has a single output node, which is the top-level node of the tree-like indicators hierarchy created in the input and middle layers. The top-level output node summarizes environment's operational load into a single number. There may be a need to replicate the middle and output layers if the ED manager needs to look separately on the different load scores for different user roles.

Network Weighting—Gradient Iterative Learning from User Feedback

Learning edges' weights requires true values for a group of vectors to provide a training set. However, in some setups it is a problem to create such a group, as there is no clear load definition. This may be overcome by creating some arbitrary initial function and updating it until the definition is acceptable. Particularly, this can be done with initializing network edges' weights randomly or manually according to some ranking system.

After the above, there are a random set of initial weights on the edges which produce some output load value. The framework is then ready to receive feedback from users to fix the edge weights toward the desired value.

Even if users do not have an explicit knowledge of the desired load function they still can feedback regarding the load gradient. In order to do so, a reference point should be provided to the user. For example, average function value over some period of time/set of input vectors should be calculated. Further on, the resulting load score should be presented comparing to this average (or another reference point). For example, if the current load is 170% of the average, users can give feedback if they “feel” that the system does not truly reflect the actual load.

In the described system a display of the estimated load is provided. The display may include the overall estimated load as well as optionally the calculated load measurements for internal nodes. In one embodiment, four feedback buttons may be provided; namely, “significantly more”, “significantly less”, “slightly more”, and “slightly less” for achieving better learning performance. The granularity may be changed according to specific user environment or needs. Such feedback will provide the function gradient direction. Receiving the desired function gradient direction in addition to the predefined step size (which can be a function of the learned vectors number, time or number of steps) allows the calibration of the network edges' weight and load estimation by using a back-propagation based algorithm. Using such learning settings the artificial neural network is allowed to learn load from implicit load functions and to provide to the user, a simple and comfortable feedback scenario.

### System Implementation

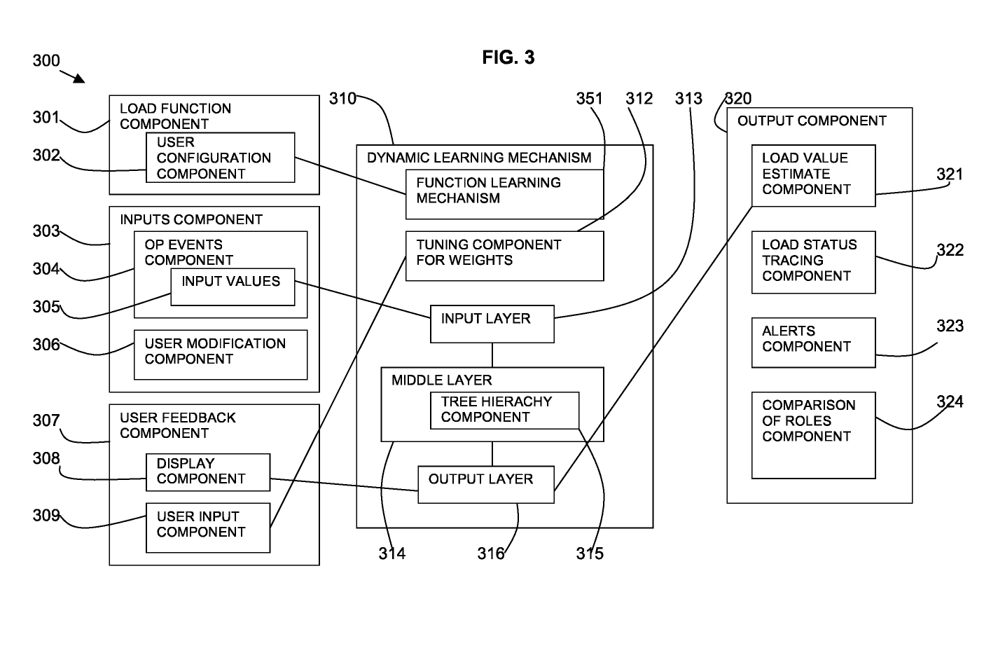

Referring to FIG. 3, a block diagram is shown of an example embodiment of the described system or framework.

A framework 300 is provided for estimating load in a user-based environment using a dynamic learning mechanism with user feedback, in this example a neural network mechanism 310 is used. The neural network mechanism 310 has an input layer 313, a middle layer 314 and an output layer 316.

The framework 300 may include a load function component 301 for explicitly defining a load function in the neural network mechanism 310. The load function component 301 may include a user configuration component 302 for a user to configure the load function. If the load function is not explicitly defined, the neural network mechanism 310 estimates an initial load function. The neural network mechanism 310 includes a dynamic learning mechanism 351 for dynamically adapting the load function from user feedback.

The framework 300 may include an inputs component 303 which may include an operational events component 304 for determining input values 305 of raw indicators of an environment being monitored. The inputs component 303 may also include a user modification component 306 for modification of the set of raw indicators being used. The inputs component 303 feeds inputs of values for a specific time to the input layer 313 of the neural network mechanism 310.

The neural network mechanism 310 may include a tuning component 312 for tuning the weights of the edges used in the neural network based on user feedback. A user feedback component 307 may be provided and may include a display component 308 which may include status indicators of the environment and a current estimated load value. The user feedback component 307 may include user input components 309 to provide feedback on the current estimated load, for example, if it should be increased or decreased incrementally.

The middle layer 314 of the neural network mechanism 310 may take two alternative forms. In a first form, the middle layer 314 is a standard hidden layer. In a second form, the middle layer 314 may include a tree hierarchy component 315 for manually creating a clustering structure in the form of a tree hierarchy for the indicators of the environment.

The framework 300 includes an output component 320 including a load value estimate component 321 for outputting the load value determined by the output layer 316 of the neural network mechanism 310. The estimated load value is also provided to the user feedback component 307 to update the current estimated load.

The output component 320 may also include a load status tracing component 322 for back tracing the tree hierarchy component 315 of the neural network mechanism to trace bottle necks of load in the environment.

The output component 320 may also include an alerts component 323 for providing an alert if an internal point of the environment reaches a threshold load.

The output component 324 may also include a comparison of user roles component 324 for comparing estimated load values for different user roles.

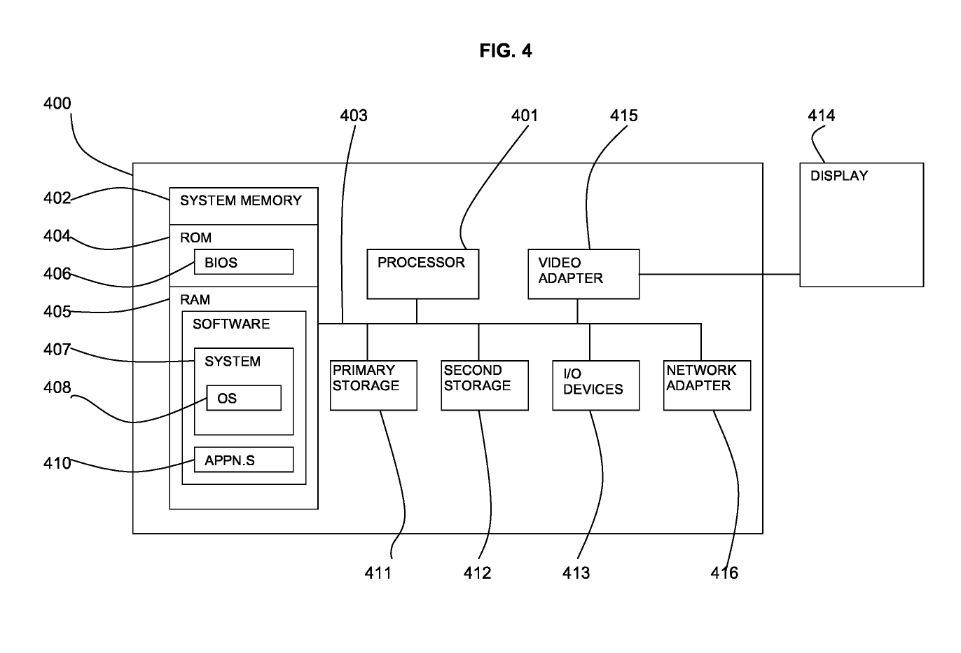

Referring to FIG. 4, an exemplary system for implementing the described framework includes a data processing system 400 suitable for storing and/or executing program code including at least one processor 401 coupled directly or indirectly to memory elements through a bus system 403. The memory elements can include local memory employed during actual execution of the program code, bulk storage, and cache memories which provide temporary storage of at least some program code in order to reduce the number of times code must be retrieved from bulk storage during execution.

The memory elements may include system memory 402 in the form of read only memory (ROM) 404 and random access memory (RAM) 405. A basic input/output system (BIOS) 406 may be stored in ROM 404. System software 407 may be stored in RAM 405 including operating system software 408. Software applications 410 may also be stored in RAM 405.

The system 400 may also include a primary storage means 411 such as a magnetic hard disk drive and secondary storage means 412 such as a magnetic disc drive and an optical disc drive. The drives and their associated computer-readable media provide non-volatile storage of computer-executable instructions, data structures, program modules and other data for the system 400. Software applications may be stored on the primary and secondary storage means 411, 412 as well as the system memory 402.

The computing system 400 may operate in a networked environment using logical connections to one or more remote computers via a network adapter 416.

Input/output devices 413 can be coupled to the system either directly or through intervening I/O controllers. A user may enter commands and information into the system 400 through input devices such as a keyboard, pointing device, or other input devices (for example, microphone, joy stick, game pad, satellite dish, scanner, or the like). Output devices may include speakers, printers, etc. A display device 414 is also connected to system bus 403 via an interface, such as video adapter 415.

### Harnessing Neural Networks to Calculate Load in the ED

An example embodiment is provided of a neural network that uses as raw indicator inputs the measures presented in “Emergency department crowding: Consensus development of potential measures” by Solberg L I, Asplin B R, Weinick R M, Magid D J, Annals of Emergency Medicine, 2003; 42(6):824-834. The authors of this study identified measures of emergency department (ED) and hospital workflow that would be of value in understanding, monitoring, and managing crowding. A national group of 74 experts developed 113 potential measures using a conceptual model of ED crowding that segmented the measures into input, throughput, and output categories. Ten investigators then used group consensus methods to revise and consolidate them into a refined set of 30 measures that were rated by all 74 experts. This is used as a basic network for the load calculation.

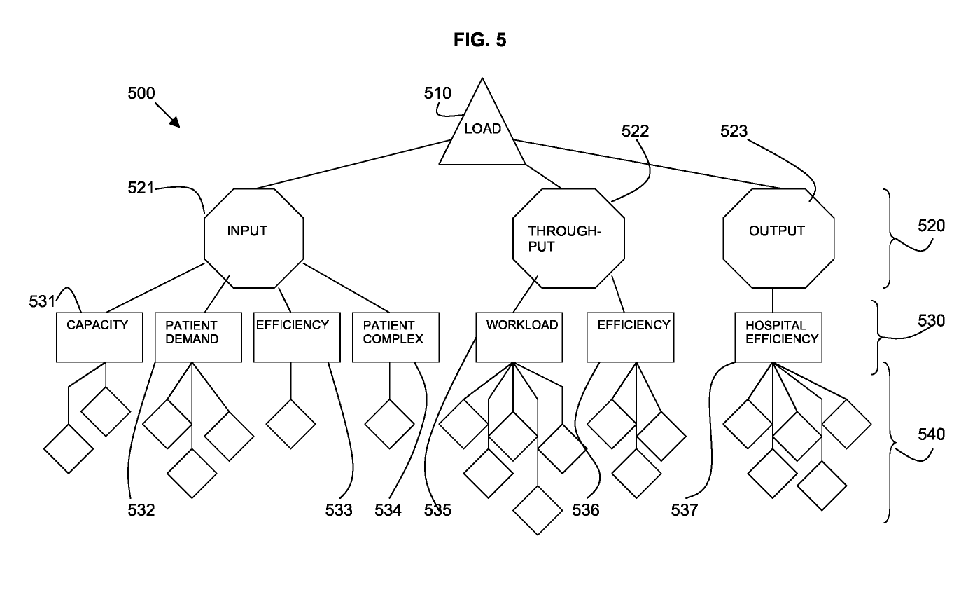

Referring to FIG. 5, a diagram shows a tree-hierarchy 500 of a neural network for an emergency department. For the set of inputs, the set of indicators are taken that were defined in the review paper above and combined and ranked in a hierarchical manner. The hierarchy 500 in the network consists of four main layers 510, 520, 530, 540.

The bottom layer is the indicators layer 540 with individual input indicator neurons shown as diamonds. This layer is the set of inputs and, in this example, consists of nodes corresponding to indicators that appeared in the review paper above.

The next layer up is the concepts layer 530 and is made up of concept neurons shown as rectangles. The indicators in the indicators layer 540 are connected (each indicator to a single concept) to the following six concepts: patient demand 532, patient complexity 534, ED capacity 531, ED efficiency 533, 536, ED workload 535, and hospital efficiency 537. The ED efficiency concept was divided into two sub-concepts 533, 536 to serve the input and the throughput separately. This modification was made to keep the tree-like structure of the network.

The next layer up is the operational stages layer 520. The concepts are connected (one concept to each operational stage) to the following three operational stages: input 521, throughput 522, and output 523.

The top layer is the load score layer 510. This layer is the output layer and consists of a single node 510 representing the total load function score.

### Second Embodiment

### Linear Regression Mechanism

Another example of a machine learning mechanism that may be used in the described method and system is a linear regression mechanism.

First, similar to the previous (ANN) solution, one should define all the input load indicators relevant to the environment. Further on, all such indicators are treated as x=(x₁ . . . xₚ), where p is the number of indicators.

Second, load ranks are defined relevant to the situations in the environment. It can be: “Low”, “Below Average”, “Average”, “Above Average”, “High” or other granularity.

The vector of weights β=(β₁ . . . βₚ) will be calculated from the input data according to the feedback from the specific user.

Third, user will provide a set of rankings for several (N) situations, i.e. a rank score (r) for each situation (x).

Then, the following optimization problem will be solved:

$${min}_{{β}_{1} … {β}_{p}} \{ {\sum }_{i = 1}^{N} {ɛ}_{i}^{2} \}$$

$$s . t . \\ {r}_{i} = {β}_{1} {x}_{i 1} + … + {β}_{p} {x}_{ip} + {ɛ}_{i}$$

This will give us the set of weights β=(β₁ . . . βₚ) describing the load pressure felt by a specific user in the specific environment.

Further on, the load (L) for the situation (x) will be defined by formulae:

L(xᵢ)=β₁xᵢ₁+ . . . +βₚxᵢₚ

### User Feedback and Display Interface

In the dynamic learning embodiment, a target function can be learnt using either the offline or online method. Both approaches require knowledge of the true target function values on some set of input vectors. This means that each such vector needs to be presented to the expert user and receive the desired function value in return. However, this flow cannot be used for two main reasons. First, input vectors are often too long for human perception and embedding. Second, the desired value of the target function cannot be explicitly calculated.

In the described framework, instead of presenting the input vector itself, current ED status may be presented using a patient-centric display or dashboard. The dashboard displays the load calculation on each node and enables user feedback on the calculated load. Feedback may also be collected on internal nodes.

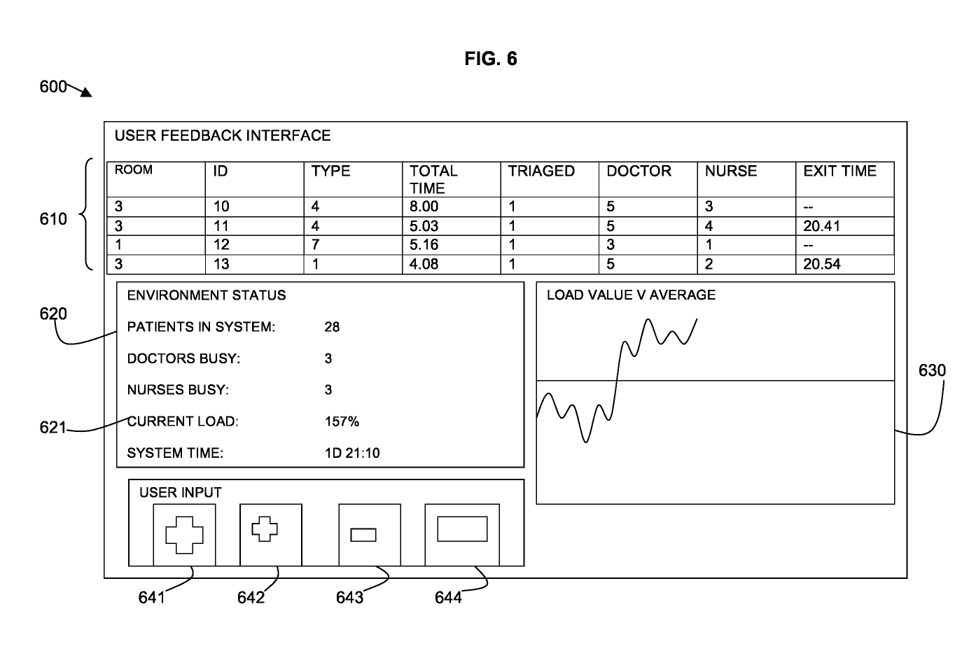

Referring to FIG. 6, a diagram shows an example embodiment of a user feedback interface 600. The interface 600 may include table 610 which provides ED staff with information about the status of each patient in the ED. Patient status is usually presented as a row within a table-like view including rows such as Room, ID, Type, Total Time, Triaged, Doctor, Nurse, Exit Time in order to record the status of each aspect of a patient. This approach is commonly used in EDs around the world.

An environment status 620 may provide further summary information including the current load 621. A graph 630 may be provided showing the load value over time as a percentage of the average.

By working with the interface 600, the ED staff gains total insight regarding the operational ED load. This insight is used to enter feedback into the framework, thus enabling it to learn the required load function. A user providing feedback via the interface 600 may be identified together with their role in the environment.

The user may provide feedback by using the dedicated feedback buttons 641-644. For example, if the user feels that the represented load is far below the desired value, he pushes the larger “+” button 641, increasing the current load by 10% increments. A similar update process (+1%, −1%, −10%) works for other feedback buttons 642, 643, 644. As an alternative, a sliding scale of feedback may be used. Such a feedback interface can be implemented in any existing dashboard without significant changes.

### Tracing Load and Bottlenecks

In the embodiment of the described framework in which a tree-hierarchy of the middle layer of the neuron network is created, every neuron has an explicit operational meaning. The neuron network design keeps the tree-like neuron hierarchy instead of the usual all-to-all connections. This allows each neuron to preserve its operational meaning during the learning process. Conserving the tree-like structure allows the user to trace the current load back into the network and to gain a deeper understanding of the current load status.

Moreover, an alert can be generated from any hierarchy level in the system if a certain neuron becomes overloaded. An alert level may be set in the dashboard and fired from internal nodes. For example, if the current system load is only 40% of the average but the X-ray room is overcrowded due to lack of personnel, the appropriate neuron's status will reach the high mark, and can alert the user, provided the neuron was preconfigured accordingly. As a result, the ED manager may react by temporarily adding to the X-ray room staff.

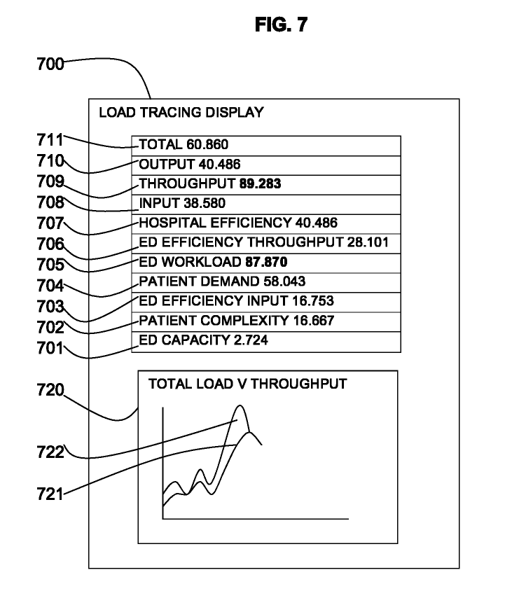

Referring to FIG. 7, a diagram shows a load tracing display 700 in which each hierarchical neuron 701-710 from the concepts layer and operational stages layer of FIG. 5, as well as the total load 711 is displayed with an associated load as a percentage. A graph 720 shows a first line 721 indicating total load, and a second line 722 indicating throughput. Throughput in this context relates to the ED high level sections that affect the load; namely: the input section (e.g. patients that arrive at the ED), the throughput section (e.g. the service times), and the output section (e.g. the wards are overloaded and patients cannot be transferred from the ED to the ward). The rise in the total load 711 was clearly caused by increase in the load of the throughput neuron 709. This can be traced further and deduced that the peak in throughput was caused by elevation of the ED workload concept neuron 705.

### Comparing Different Views on ED Load

The described framework allows dynamic learning based on feedback from different roles of users. Several different load views can be calculated and presented for the same objective situation. For example, measuring the current ED load as perceived by doctors, nurses, and patients, or even by a single individual such as the ED manager, could have interesting applications. Having an option for defining a subjective load function that best reflects the actual load experienced by a given role may also be very useful.

To demonstrate the system's ability to reflect subjective load, three possible roles are identified: nurse, doctor, and patient. The user profile reflects operational load as it is being experienced by a given role, or even by a specific individual within the ED. User profiles can be statically defined by fixing weights on relevant neurons, or preferably, by dynamically learning the user profile for a member of a role. Dynamic learning involves capturing user feedback from a specific user or role associated with a relevant profile.

When an environment is overloaded, all users generally feel it. However, the load experience may be different for each role. For example, doctors need to stay later than nurses at the end of the day and to close all open cases. Thus, the load on them decreases later than it does for nurses. On the other hand, triage, served by nurses, is the first station in the patient flow. Hence, the nurses' operational load starts earlier. These examples demonstrate that there are indeed different weights on the neurons, emphasizing the need for subjective load scores for the same objective ED state.

The core of the described framework is a dynamic learning mechanism that enables the following features:
Users can modify the set of basic indicators collected from the environment infrastructure.
Users can configure the system with any kind of load function.
In cases where the load function cannot be defined explicitly, the framework provides an adaptive mechanism that learns the desired load function autonomously. A display is provided representing the system's view of the load enabling user feedback. Learning from the user feedback on the calculated load is carried out, while viewing snapshots of environment states and the corresponding calculated load.
The system also offers advanced capabilities for tracking the origin of the load status and for understanding its cause at different levels of granularity. Moreover, the system can provide specific alerts regarding the high load values at various predefined internal points, even if the total load in the system is low.
The system enables comparison among various calculations of load, according to the perception of different roles in the environment.

The described framework is a flexible and adaptive framework for load calculation that comes with a set of initial measures and a set of load functions. The framework can be easily enhanced with additional measures and load functions. Moreover, the system includes a mechanism to learn the load function from the user, in cases where this could not be explicitly defined. This learning mechanism is used to define user profiles, each with its own view and requirements, from the calculation of load in the ED environment.

Measuring load is a crucial step for optimizing operation in high pressure environments such as emergency departments. This measure of load can be used in various ways. First, it can be used to optimize the staff routing inside the environment at times of high load levels. Using the offline method, load calculation can be used to provide detailed planning for different staff members in the environment (e.g., nurses, physicians). Providing a highly adaptable measuring tool, may prove useful in many situations in which global agreement about measured indicators is out of reach.

One of the advantages of the described framework is its flexibility to fit specific user needs, and its ability to handle and learn from highly undefined data that represents subconscious user perceptions. The implementation can be integrated into current ED dashboard systems and other existing high pressure environment systems. The received user-specific load score can also be used for operation optimization and for providing advice to personnel.

The estimated load can also be used for providing load status externally to the personnel of the environment. For example, a patient considering which ED to approach at a specific point in time, may view the load status of multiple EDs.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for load estimation in a user-based environment, comprising:
inputting a set of time-dependent, raw operational indicators of the environment;
creating a load function according to the specific needs of the environment;
displaying an estimated load;
receiving user feedback on the estimated load;
applying a dynamic learning mechanism to generate a user-tuned load function for estimating load on the environment;

2. The method as claimed in claim 1, wherein receiving user feedback on the estimated load includes an indication of the user's role in the environment.

3. The method as claimed in claim 1, wherein the dynamic learning mechanism allows adjustment of load estimation towards a user's role.

4. The method as claimed in claim 1, wherein inputting a set of raw operational indicators includes processing operational events to generate time-dependent input values.

5. The method as claimed in claim 1, wherein the set of raw operational indicators is modifiable by a user.

6. The method as claimed in claim 1, wherein the feedback from different users is provided on the estimated load whilst viewing displayed snapshots of states of the environment.

7. The method as claimed in claim 1, wherein creating a load function according to the specific needs of the environment estimates a load function.

8. The method as claimed in claim 1, wherein the dynamic learning mechanism is in the form of one of the group of: an artificial neural network mechanism, or a linear regression mechanism.

9. The method as claimed in claim 1, wherein the dynamic learning mechanism includes a hidden middle layer.

10. The method as claimed in claim 1, wherein the dynamic learning mechanism includes an internal function structure used to trace load origin and behaviour.

11. The method as claimed in claim 10, wherein the internal function structure is a manually created tree hierarchy of clusters of indicators as internal nodes of a network of the mechanism.

12. The method as claimed in claim 10, including displaying estimated load values for internal nodes and receiving user input on the estimated load values.

13. The method as claimed in claim 10, including providing an alert if a high load value is reached at a node of the network of the mechanism.

14. The method as claimed in claim 1, including comparing estimated load values tuned by feedback from different user roles.

15. The method as claimed in claim 1, wherein the user feedback on the estimated load is provided in incremental steps to increase or decrease the estimated load.

16. A computer program product for load estimation in a user-based environment, the computer program product comprising:
a computer readable storage medium having computer readable program code embodied therewith, the computer readable program code comprising:
computer readable program code configured to:
inputting a set of time-dependent, raw operational indicators of the environment;
creating a load function according to the specific needs of the environment;
displaying an estimated load;
receiving user feedback on the estimated load;
applying a dynamic learning mechanism to generate a user-tuned load function for estimating load on the environment.

17. A system for load estimation in a user-based environment, comprising:
a processor;
an inputs component for inputting a set of time-specific, raw operational indicators of the environment;
a load function component for providing a load function according to the specific needs of the environment;
a display component for displaying an estimated load on the environment;
a user input component for inputting user feedback on the estimated load;
a dynamic learning mechanism for applying dynamic learning to generate a user-tuned load function for estimating load on the environment.

18. The system as claimed in claim 17, wherein the display component is for displaying an overall estimated load on the environment.

19. The system as claimed in claim 17, including a load status tracing component for back-tracing the load estimation through the machine learning mechanism.

20. The system as claimed in claim 17, wherein the display component includes displays for the estimated load of internal nodes representing aspects of the environment.

21. The system as claimed in claim 17, wherein a user input component includes input buttons for incremental increases and decreases in the estimated load.

22. The system as claimed in claim 17, including a user identification component for identifying the user providing feedback, including identifying the role of the user in the environment.

23. The system as claimed in claim 17, including an alert mechanism for firing an alert when a node representing an aspect of the environment reaches a threshold.

24. The system as claimed in claim 23, including a user alert setting component for setting an alert via the user input component.

25. The system as claimed in claim 17, including a comparison component for comparison of load estimation for different user roles.
